(19) United States
(12) Patent Application Publication
(10) Pub. No.: US 2021/0229230 A1
(43) Pub. Date: Jul. 29, 2021

(54) Gear Shifting Structure of Power Equipment and Electrically-Driven Tool Comprising Same

(71) Applicant: HOSAN TECHNOLOGIES CO., LTD., Gyeonggi-do (KR)

(72) Inventor: No-Soo Song, Seoul (KR)

(21) Appl. No.: 17/270,922

(22) PCT Filed: Aug. 1, 2019
(86) PCT No.: PCT/KR2019/009607

§ 371 Date: Feb. 24, 2021

(30) Foreign Application Priority Data
Aug. 28, 2018 (KR) 10-2018-0101495

(51) Int. Cl. B23Q 5/14; B23B 39/12; B23Q 5/04; B23Q 11/04

(52) U.S. Cl. CPC B23Q 5/142; B23B 39/12; B23Q 5/048; B23B 2260/044; B23B 2260/07; B23Q 2705/06; B23Q 11/04

(57) ABSTRACT

The present invention provides, in an embodiment, a gear-shifting structure of power equipment, the gear-shifting structure comprising: first and second gears having shafts concentric with a first shaft, respectively, the first and second gears being positioned at different locations along the axial direction of the first shaft, the first and second gears having protrusions formed thereon, respectively, and the first and second gears freely rotating with regard to the first shaft; a clutch disposed concentrically with the first shaft between the first and second gears, the clutch being spline-coupled to the first shaft, and the clutch having engaging members formed thereon so as to protrude toward the first and second gears, respectively; an adjustment member configured to move the clutch toward the first gear or the second gear; a second shaft; and third and fourth gears having shafts concentric with the second shaft, respectively, the third and fourth gears being disposed to engage with the first and second gears and to rotate together with the second shaft. The engaging members of the clutch engage with the protrusion of the first gear or the second gear by means of the adjustment member.

### TECHNICAL FIELD

The present disclosure relates to a transmission structure of power equipment and a power tool including the same.

### BACKGROUND ART

For iron processing, construction material processing, especially beam processing, ship building or even after launching of ship , drill work may be often carried out for various hole processing purposes such as a change in design, a design fault, or the like.

Such hole processing is performed a lot in various applications, as above. However, because a worker cannot directly carry a heavy drilling device, the hole processing may be performed by a magnetic drilling device having a magnet attached to a lower portion of the drilling device and adsorbing a magnet attached to a target workpiece.

FIG. 1 is a view schematically illustrating a drilling machine. FIG. 1 is a view schematically illustrating a magnetic drilling machine configured to perform drilling after fixing a target drilling machine with an electromagnet, among drilling machines.

Referring to FIG. 1, a magnetic drilling machine 1 may be configured to include a drill portion 10, a magnet portion 20, a support portion for supporting the drill portion and the magnet portion, and the like. In a case in which a hole is processed in a specific position of a steel material, as the target workpiece, after matching a tip portion 15 of the drill portion with a position in which the hole is processed when a power switch of a magnet is turned on, magnetic force is generated in the magnet when the power switch of the magnet is turned off. In this case, hole processing of the magnetic drilling machine 1 maybe performed by the magnetic force, while maintaining a state of being adsorbed to the steel material, a target to be processed.

In the magnetic drilling machine as illustrated in FIG. 1, it is necessary to adjust a rotation ratio of a drill to rotation of a motor. In the conventional case, a gear engaged with a rotating shaft may be changed with a control unit. In this method, when the gear is changed with the control unit, since the gear should be accurately engaged with the rotating shaft, there may be an inconvenience of having to engage the gear with the rotating shaft while rotating the drill portion when the user turns the control unit.

Accordingly, as in Patent Document 1, a device has been developed that allows a gear to be shifted when a control unit is turned and a motor is rotated. However, in the case of Patent Document 1, there may be a problem that it is not easy to disassemble/assemble the control unit because of the complex structure in which an elastic member is connected to the control unit.

Particularly, components such as gears should be replaced when damaged, and in most cases, users who may not be experts should replace and use the parts themselves. However, in the case of Patent Document 1, there may be a problem that it is practically impossible for users to replace such gears.

(Patent Document 1) U.S. Pat. No. 9,434,038 B2

### DISCLOSURE

### Technical Problem

An aspect of the present disclosure is to provide a transmission structure, easy to disassemble and assemble, and capable of performing a change in speed, without rotating a drill unit after operation of a control unit, and a power tool including the same.

### Technical Solution

The present disclosure provides the following configuration in order to achieve the above object.

According to an aspect of the present disclosure, a transmission structure of power equipment, includes a first shaft; a first gear and a second gear, concentric with the first shaft, located in different positions in an axis direction of the first shaft, respectively having protrusions formed to face each other, and freely rotating with respect to the first shaft; a clutch disposed between the first and second gears to be concentric with the first shaft, coupled to the first shaft in a spline-fit or key-fit manner, to be movable in the axis direction while rotating together with the first shaft, and having latch members respectively protruding in directions of the first and second gears; a control member configured to move the clutch in the direction of the first or second gear; a second shaft disposed to be parallel to the first shaft; and a third gear and a fourth gear, concentric with the second shaft, respectively disposed in engagement with the first and second gears in positions respectively corresponding to the first and second gears, and rotating together with the second shaft, wherein elastic members respectively pressing the first gear and the second gear to move toward each other, and movement limiting members respectively limiting axial movements of the first and second gears are provided, and the protrusion of the first gear or the protrusion of the second gear is latched by one of the latch members of the clutch, by the control member.

In an embodiment, the clutch may move between a first position in which a first latch member protruding in the first gear direction is latched by the protrusion of the first gear and a second position in which a second latch member protruding in the second gear direction is latched by the protrusion of the second gear, in the first shaft direction.

In an embodiment, the first latch member and the second latch member of the clutch may protrude by a predetermined interval in a circumferential direction, respectively.

In an embodiment, the movement limiting members may include a first ring fitted to the first shaft, disposed between the first gear and the second gear and limiting movement of the first gear, and including a second ring limiting movement of the second gear, or a step portion formed on the first shaft.

In an embodiment, the elastic members may include a first spring disposed opposite to a surface of the first gear facing the second gear, and concentric with the first shaft, and a second spring disposed opposite to a surface of the second gear facing the first gear, and concentric with the first shaft.

In an embodiment, the first shaft may be configured such that a cross-sectional area of one end is larger than a cross-sectional area of the other end, and at least one end portion of the first spring and the second spring may be in contact with the step portion of the first shaft.

In an embodiment, the clutch may include a first surface facing the first gear, a second surface facing the second gear, and a connection portion connecting the first surface and the second surface and having a cross-sectional area, smaller than a cross-sectional area of each of the first and second surfaces, and the control member may include a finger portion fitted into a space between the first and second surfaces and freely moving with respect to rotation of the clutch; a rotating knob exposed from an outer surface of the power equipment; and a branch portion connecting the finger portion and the rotating knob.

In an embodiment, the rotating knob may include an eccentric protrusion protruding from an eccentric position of the power equipment toward an inner surface of the power equipment, and the control member may locate the clutch in a first position or a second position by eccentric rotation of the eccentric protrusion.

According to an aspect of the present disclosure, a power tool includes a main body; a motor provided in the main body; the transmission structure according to anyone of claims 1 to 8, connected to the motor; and a tool connected to an output end of the transmission structure.

In an embodiment, an electromagnet may be provided in a lower portion of the main body, and the tool may be a drill.

### Advantageous Effects

According to an aspect of the present disclosure, a transmission structure, easy to disassemble and assemble, and capable of performing a change in speed, without rotating a drill unit after operation of a control unit, and a power tool including the same, may be provided.

### DESCRIPTION OF DRAWINGS

FIG. 1 is a view schematically illustrating a drilling machine.

FIG. 2 is a front view illustrating a transmission structure according to an embodiment of the present disclosure.

FIG. 3 is a partially exploded perspective view illustrating a transmission structure according to an embodiment of the present disclosure.

FIG. 4 is a view illustrating a control unit of a transmission structure of an embodiment of the present disclosure, FIG. 4A is a perspective view thereof, and FIG. 4B is a bottom view thereof.

FIG. 5 is a perspective view illustrating a transmission structure according to an embodiment of the present disclosure.

FIGS. 6 to 9 are views illustrating operational diagrams of a transmission structure according to an embodiment of the present disclosure.

FIG. 10A is a perspective view illustrating a clutch according to an embodiment of the present disclosure, and FIG. 10B is a side view illustrating a clutch according to an embodiment of the present disclosure.

FIG. 11 is a perspective view illustrating a transmission structure according to another embodiment of the present disclosure.

### BEST MODE FOR INVENTION

Hereinafter, example embodiments will be described in detail with reference to the accompanying drawings such that those of ordinary skill in the art may easily implement the present disclosure. However, in describing a preferred embodiment of the present disclosure in detail, if it is determined that a detailed description of a related known function or configuration may unnecessarily obscure the subject matter of the present disclosure, the detailed description thereof will be omitted. In addition, the same reference numerals may be used throughout the drawings with respect to components having similar functions and operations.

In addition, throughout the specification, when a portion may be described to be ‘connected’ with another portion, this may refer to not only ‘directly connected’, but also ‘indirectly connected’ with another element interposed therebetween. In addition, “including” a certain component may refer that other components are not excluded, other components may be further included, unless otherwise stated.

Throughout the specification, ‘on or above,’ and ‘upper,’ and ‘below,’ and ‘lower’ may refer to ‘on or above ˜,’ and ‘in an or the upper portion of ˜,’ and ‘below ˜,’ and ‘in a or the lower portion of ˜’ in the drawings, and in a case of the product, they may refer to one direction or the other direction.

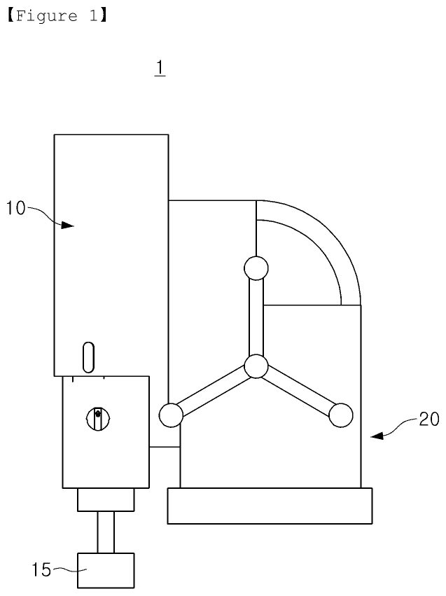

A transmission structure of the present disclosure may be applied to a conventional power tool, e.g., the magnetic drilling machine illustrated in FIG. 1. Specifically, the transmission structure of the present disclosure may connect a rotation shaft of the motor of the magnetic drilling machine 1, provided with an electromagnet in a main body, and a tool.

In this embodiment, a transmission structure of the magnetic drilling machine 1 is described. However, the present disclosure may be applied not only to the magnetic drilling machine 1, but also to various power mechanisms requiring a change in speed of gears.

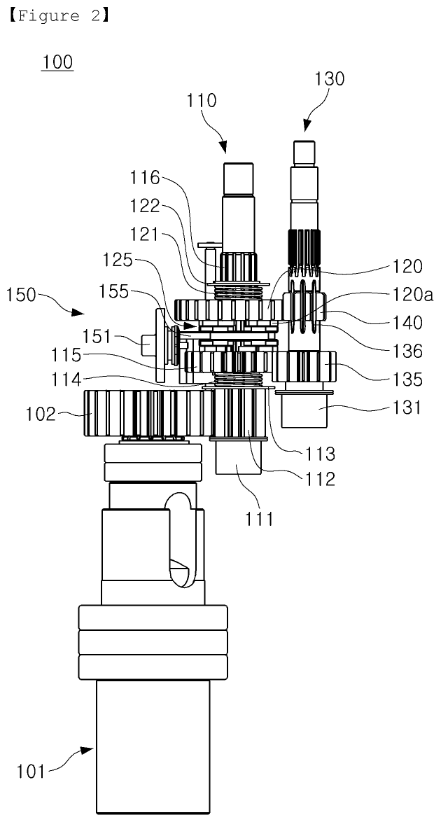

FIGS. 2 to 10 are views illustrating a transmission structure 100 of a power tool according to an embodiment of the present disclosure.

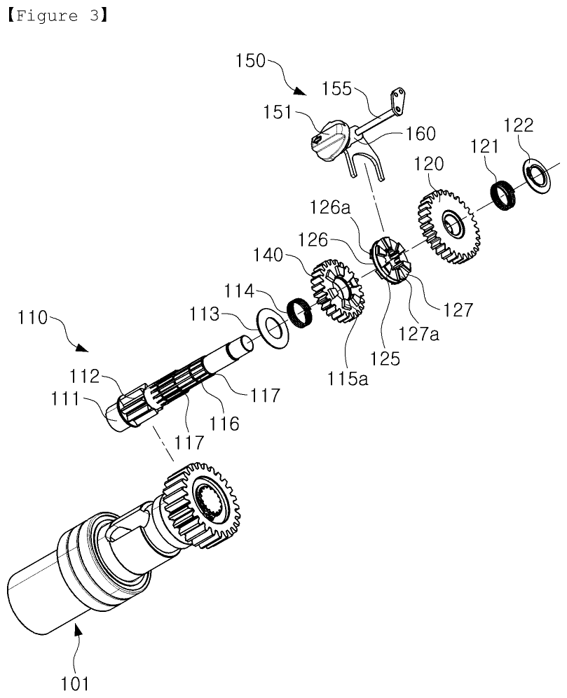

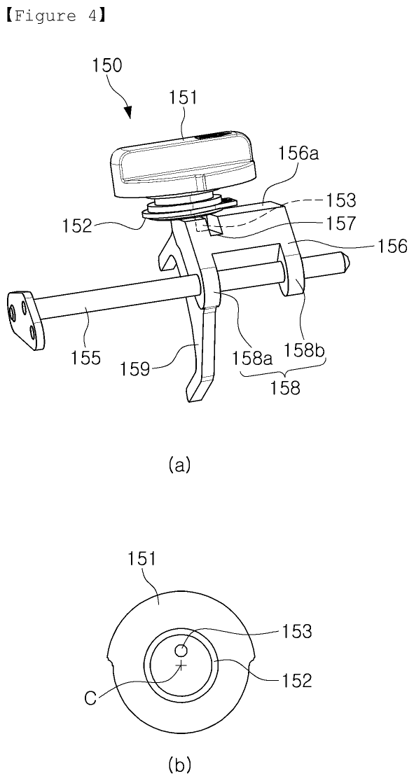

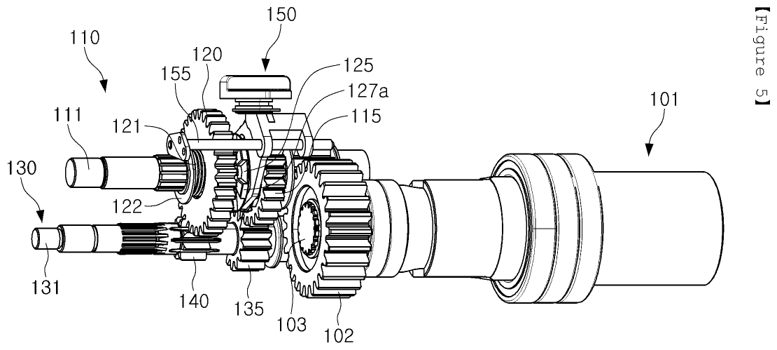

Specifically, FIG. 2 is a front view illustrating a transmission structure according to an embodiment of the present disclosure, FIG. 3 is a partially exploded perspective view illustrating a transmission structure according to an embodiment of the present disclosure, FIG. 4A is a perspective view of a control unit of a transmission structure, FIG. 4B is a bottom view of the control member, and FIG. 5 is a perspective view illustrating a transmission structure.

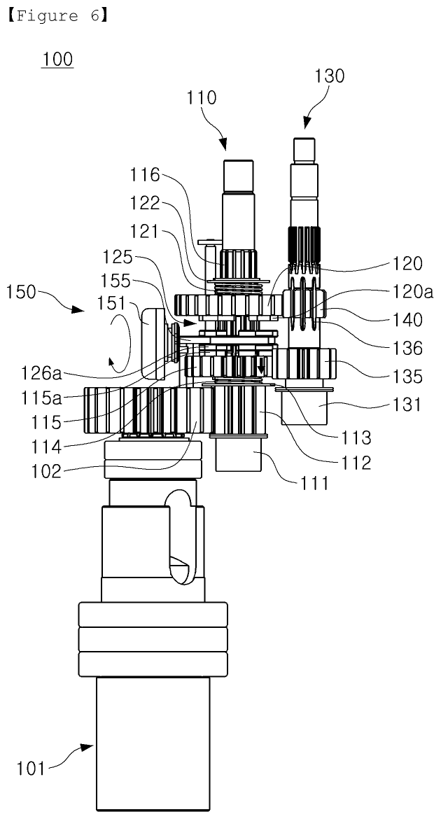

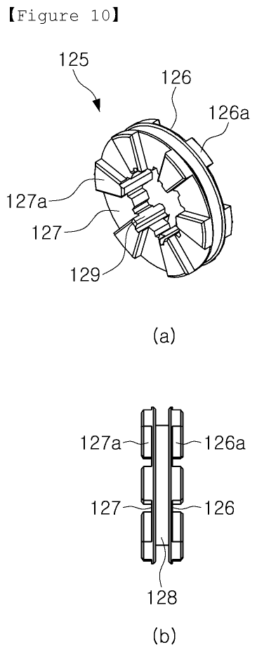

FIGS. 6 to 9 are views illustrating operational diagrams of a transmission structure according to an embodiment of the present disclosure, FIG. 10A is a perspective view illustrating a clutch according to an embodiment of the present disclosure, and FIG. 10B is a side view illustrating a clutch according to an embodiment of the present disclosure.

As illustrated in FIGS. 2, 3, and 5, a transmission structure 100 according to an embodiment of the present disclosure may be connected to a motor (not illustrated) by a drive gear rotating together with a rotation shaft of the motor, to rotate a second shaft 131, a rotation shaft of a second gear group 130.

The transmission structure 100 may include a first gear group 110 including a first shaft 111, a second gear group 130 including a second shaft 131, and a control member 150 controlling a change in speed.

The first gear group 110 may include a first shaft 111; a pinion 112 integrally formed with the first shaft 111 and rotating a gear 102 connected to a spindle 101; first and second gears 115 and 120, concentric with the first shaft 111, located in different positions in an axis direction of the first shaft 111, respectively having protrusions 115a and 120a formed to face each other, and freely rotating with respect to the first shaft 111; and a clutch 125 disposed between the first and second gears 115 and 120 to be concentric with the first shaft 111, movable in the axis direction while rotating together with the first shaft 111, coupled to a spline 116 of the first shaft 111 in a spline-fit manner, and having latch members 126a and 127a respectively protruding in directions of the first and second gears 115 and 120. In this case, as a manner in which the first shaft 111 and the clutch 125 rotate together, a key-fit manner maybe provided, in addition to the spline-fit manner, and other manners may be also applied.

The second gear group 130 may include a second shaft 131 disposed to be parallel to the first shaft 111; and third and fourth gears 135 and 140, concentric with the second shaft 131, respectively disposed in engagement with the first and second gears 115 and 120 in positions respectively corresponding to the first and second gears 115 and 120, and rotating together with the second shaft 131. In this case, the third and fourth gears 135 and 140 may be pinions formed integrally with the second shaft 131.

The control member 150 may be configured to move the clutch 125 in the direction of the first gear 115 or the second gear 120, and a detailed configuration will be described later with reference to FIG. 4.

The first gear group 110 may be prepared by arranging and assembling the pinion 112, a support ring 113, a spring 114, the first gear 115, the clutch 125, the second gear 120, a spring 121, and a support ring 122 in sequence in an upward direction. In particular, in the present disclosure, an elastic member such as the springs 114 and 121 may be fitted along the first shaft 111, and the gears 115 and 120, moving by the springs 114 and 121, may be easy to assemble them because movement thereof is restricted by the rings 113 and 122 or a step portion 117.

As seen in FIG. 2, a lower portion of the first gear 115 may be in contact with the spring 114 to be pushed in the direction of the second gear 120, and may be limited in the direction of the second gear 120, by a ring (not illustrated) fitted into the first shaft 111. A lower surface of the spring 114 maybe supported by the support ring 113, and an upper surface of the spring 114 may be in contact with the first gear 115. In this case, when the first gear 115 is pressed in a downward direction, the spring 114 may be elastically deformed to move the first gear 115 in the downward direction, and when the pressure is released, the first gear 115 maybe returned to its original position by elastic restoring force.

Movement of a lower portion of the second gear 120 in the axis direction may be limited by the step portion 117, and an upper portion of the second gear 120 may be supported by the spring 121. A lower surface of the spring 121 may be in contact with the second gear 120, and an upper surface of the spring 121 may be supported by the support ring 122. The second gear 120 may be latched by the step portion 117 of the first shaft 111. In this case, when the spring 121 is pressed in the upward direction, the spring 121 may be elastically deformed to move the second gear 120 in the upward direction, and when the pressure is released, the second gear 120 may be returned to its original position by elastic restoring force.

As illustrated in FIG. 3 or 10, the clutch 125 may be disposed between the first gear 115 and the second gear 120. The first gear 115 and the second gear 120 may be spaced apart from each other by at least a thickness of the clutch 125 including the latch members 126a and 127a. The first gear 115 and the second gear 120 may be spaced farther apart from each other, when a movement distance according to rotation of a knob 151 is sufficiently secured. The first gear 115 and the second gear 120 should be spaced apart from each other by a distance such that the latch members 126a and 127a do not latch both of the protrusions of the gears.

The clutch 125 may include A lower surface 126 facing the first gear 115; an upper surface 127 facing the second gear 120; a connection portion 128 connecting the lower surface 126 and the upper surface 127 and having a cross-sectional area, smaller than a cross-sectional area of each of the lower surface 126 and the upper surface 127; and a spline 129 formed therein. A first latch member 126a may be formed by protruding from the lower surface 126, and a second latch member 127a may be formed by protruding from the upper surface 127.

In the clutch 125, the first latch member 126a and the second latch member 127a may protrude at regular intervals in the circumferential direction, and may have a shape that may be fitted into a gap between the protrusion 115a of the first gear 115 and the protrusion 120a of the second gear 120, respectively.

The control member 150 will be described with reference to FIG. 4. The control member 150 may include a finger portion 159 surrounding the connection portion 128, fitted into a space between the lower surface 126 and the upper surface 127, and freely moving with respect to rotation of the clutch; a knob 151 rotatable and exposed from an outer surface of the power equipment; and a branch portion 156 connecting the finger portion 159 and the knob 151. The branch portion 156 may include a plurality of guide portions 158a and 158b having through-holes into which a guide bar 155, connected to the power equipment and parallel to the first shaft 111, is fitted, to move along the guide bar 155 in a certain direction, even when the knob 151 is rotated. The knob 151 may include an eccentric protrusion 153 protruding eccentrically with respect to a rotation center C on a surface 152 facing the branch portion 156. The eccentric protrusion 153 may be fitted into a groove 157 formed in a surface of the branch portion 156, facing the knob 151.

Therefore, when the knob 151 is rotated, the eccentric protrusion 153 may be rotated, and the eccentric protrusion 153 may move in the groove 157 and may move the branch portion 156 along the guide bar 155 in the upward or downward direction. In this case, since the finger portion 159 of the branch portion 156 is fitted between the lower surface 126 and the upper surface 127 of the clutch 125, the clutch 125, together with the branch portion 156, may move in the axis direction of the first shaft 111 in the upward or downward direction.

The transmission structure 100 of the present disclosure will be described in detail with respect to FIGS. 6 to 9.

FIG. 6 illustrates a state in which the knob 151 of the control member 150 is rotated to move the clutch 125 to a first position in which the clutch 125 rotates together with the first gear 115. When the clutch 125 is moved in the upward direction, the first latch member 126a of the clutch 125 may be fitted between the protrusions 115a of the first gear 115. As illustrated in FIG. 6, in relatively many cases, the first latch member 126a may collide with the protrusion 115a of the first gear 115. In this case, when the clutch 125 is moved to the first position, the first gear 115 may move by a height of the first latch member 126a while compressing the spring 114, in the downward direction.

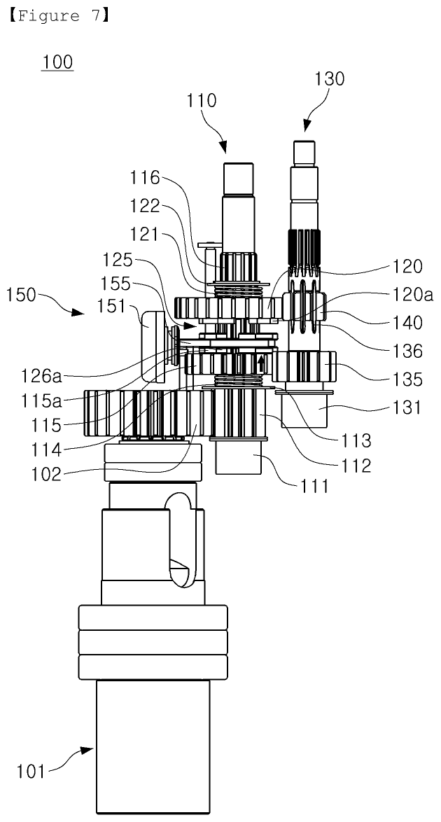

In this state, when the motor (not illustrated) is driven, as illustrated in FIG. 7, the third gear 135 of the second shaft 131 may be rotated, and the first gear 115 engaged with the third gear 135 may be rotated, to fit the first latch member 126a between the protrusions 115a of the first gear 115. In this case, the first gear 115 pressed in a direction facing the clutch 125 by the spring 114 may move in the upward direction, to fit the first latch member 126a between the protrusions 115a of the first gear 115 to rotate the first gear 115 and the clutch 125 together.

When the first gear 115 is rotated together with the clutch 125, the first shaft 111 rotating together with the clutch 125 may be rotated, to perform a change in speed according to a gear ratio of the first gear 115 and the third gear 135. In this case, although the second gear 120 and the fourth gear 140 may be also engaged, the second gear 120 may not be connected to the clutch 125. Therefore, since the second gear 120 may not rotate together with the first shaft 111, a change in speed by the first gear 115 may not be affected.

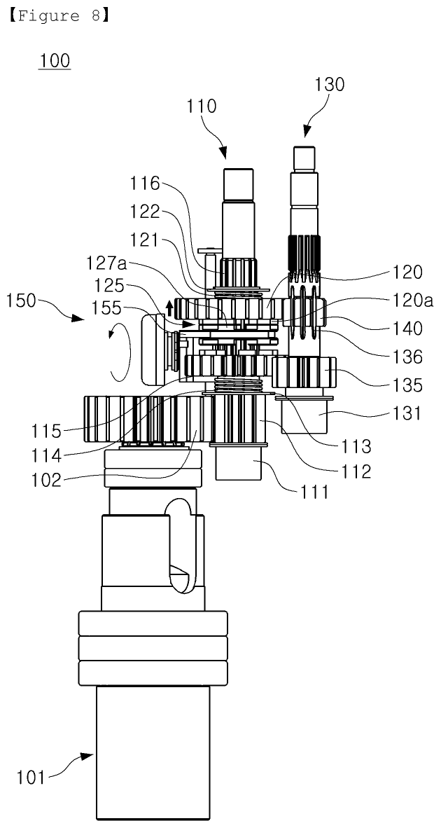

FIG. 8 illustrates a state in which the knob 151 of the control member 150 is rotated in the opposite direction to move to a second position in which the clutch 125 rotates together with the second gear 120. When the clutch 125 is moved in the upward direction, the second latch member 127a of the clutch 125 may be fitted between the protrusions 120a of the second gear 120. As illustrated in FIG. 8, in relatively many cases, the second latch member 127a may collide with the protrusion 120a of the second gear 120. In this case, when the clutch 125 is moved to the second position, the second gear 120 may move by a height of the second latch member 127a while compressing the spring 121, in the downward direction.

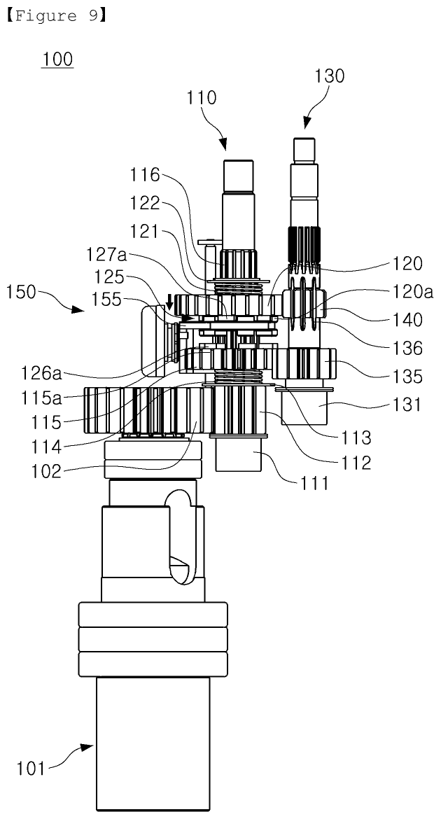

In this state, when the motor (not illustrated) is driven, as illustrated in FIG. 9, the fourth gear 140 of the second shaft 131 may be rotated, and the second gear 120 engaged with the fourth gear 140 may be rotated, to fit the second latch member 127a between the protrusions 120a of the second gear 120. In this case, the second gear 120 pressed in a direction facing the clutch 125 by the spring 121 may move in the upward direction, to fit the second latch member 127a between the protrusions 120a of the second gear 120 to rotate the second gear 120 and the clutch 125 together.

When the second gear 120 is rotated together with the clutch 125, the first shaft 111 rotating together with the clutch 125 may be rotated, to perform a change in speed according to a gear ratio of the second gear 120 and the fourth gear 140. In this case, although the first gear 115 and the third gear 135 may be also engaged, the first gear 115 may not be connected to the clutch 125. Therefore, since the first gear 115 may not rotate together with the first shaft 111, a change in speed by the second gear 120 may not be affected.

In a transmission structure 100 according to the present disclosure, a change in speed according to a gear ratio of the first gear 115 and the third gear 135, and a change in speed according to a gear ratio of the second gear 120 and the fourth gear 140 may be accomplished by the control member 150. In this case, when the clutch 125 is moved to the first position or the second position by the control member 150, the first gear 115 or the second gear 120 and the clutch 125 may be engaged and rotated by elastic force of the springs 114 and 121 while rotating the first gear 115 or the second gear 120 according to rotation of the motor. Therefore, there is no need to perform a change in speed of the gears while holding the tool with a hand during a change in speed of the gears.

In addition, in a transmission structure 100 according to the present disclosure, springs 114 and 121, which may be elastic members, may be disposed on the first shaft 111, and the gears and the springs may be supported by the rings or the step portions. Therefore, it may be easy to assemble the transmission structure in sequence. In particular, because the elastic member may not be disposed on the control member 150, it may be easy to disassemble and assemble the transmission structure. Therefore, a user intended to use a power tool, other than a professional engineer, may directly disassemble the transmission structure 100, and may replace component(s) of interest therein with alternative(s) and re-assemble the replaced alternative(s), when there is damage in component(s) such as gears or the like.

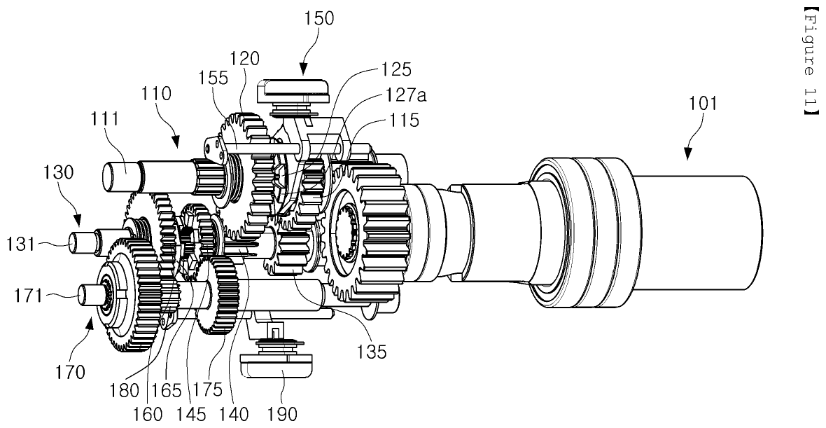

FIG. 11 illustrates a transmission structure according to another embodiment of the present disclosure. As illustrated in FIG. 8, a transmission structure 100 of FIG. 11 may include a third gear group 170, in addition to a first gear group 110 and a second gear group 130.

A structure of the first gear group 110 may be the same as in the embodiments of FIGS. 2 to 10, and thus description thereof will be omitted.

Structures of third and fourth gears 135 and 140 in the second gear group 130, engaged with a first gear 115 and a second gear 120, may be also the same as in the embodiments of FIGS. 2 to 10. A fifth gear 145 and a sixth gear 160 may be spaced apart from each other in the axis direction above the fourth gear 140, and a second clutch 165 may be disposed between the fifth gear 145 and the sixth gear 160. The fifth gear 145 and the sixth gear 160 may be arranged in the same manner as a relationship between the first gear 115 and the second gear 120, described above. For example, the fifth gear 145 and the sixth gear 160 may be disposed to be spaced apart from each other to correspond to a thickness of the second clutch 165 in the axis direction of the second shaft 131. Protrusions may be respectively formed on the fifth gear 145 and the sixth gear 160 to face the second clutch 165. Latch members may be respectively formed on the second clutch 165 to face the fifth gear 145 and the sixth gear 160. In addition, a spring may be disposed opposite to a surface of the sixth gear 160 facing the fifth gear 145, and a spring may be also disposed opposite to a surface of the fifth gear 145 facing the sixth gear 160. The fifth gear 145 and the sixth gear 160 may freely rotate with respect to the second shaft 131, and the second clutch 165 may be rotated together with the second shaft 131.

Movement of the second clutch 165 in the axis direction may be determined by a second control member 190. The second control member 190 may have a structure, identical to the structure of the first control member 150.

The third gear group 170 may include a third shaft 171 parallel to the second shaft 131; a seventh gear 175 rotating together with the third shaft 171 and engaged with the fifth gear 145; and an eighth gear 180 rotating together with the third shaft 171 and engaged with the sixth gear 160.

A gear ratio of the fifth to eighth gears may be changed by the second clutch 165, which may be the same principle as the first to fourth gears, described above, changed by the first clutch 125. Therefore, a detailed description thereof will be omitted.

In this embodiment, since there are two (2) control members 150 and 190, a ratio of changes in speed of rotation of a motor may be further expanded by a combination of the two (2) control members 150 and 190.

In the present disclosure, the gears 115, 120, 145, and 160 adjacent to the clutches 125 and 165, in the axis direction, among the gears 115, 120, 135, 140, 145, 160, 175, and 180, may be configured to move in the axis direction according to movement of the clutches 125 and 165. Movement of the gears 115, 120, 145, and 160 may be limited by a step portion formed on a ring or a shaft, such that a plurality of gears 115, 120, 145, and 160 are not coupled to each of the clutches 125 and 165. In addition, springs offering elastic force to the gears 115, 120, 145, and 160 may also be supported by a step portion formed on a ring or a shaft in opposite end portions of the gears 115, 120, 145, and 160.

Although it has been illustrated that the third to sixth gears are connected to the second shaft 131 in the embodiment of FIG. 11, the fifth and sixth gears 145 and 160 may be disposed on another shaft, rotating together.

Although it has been illustrated that the clutches 125 and 165 of the shift structure are disposed farther from the motor as the driving unit in the above embodiments, the first and second axes may be arranged in an opposing manner, e.g., the clutches 125 and 165 may be disposed adjacent to the motor as the driving unit.

While example embodiments have been illustrated and described above, it will be apparent to those skilled in the art that modifications and variations could be made without departing from the scope of the present disclosure as defined by the appended claims.

1. A transmission structure of power equipment, comprising:
a first shaft;
a first gear and a second gear, concentric with the first shaft, located in different positions in an axis direction of the first shaft, respectively having protrusions formed to face each other, and freely rotating with respect to the first shaft;
a clutch disposed between the first and second gears to be concentric with the first shaft, coupled to the first shaft in a spline-fit or key-fit manner, to be movable in the axis direction while rotating together with the first shaft, and having latch members respectively protruding in directions of the first and second gears;
a control member configured to move the clutch in the direction of the first or second gear;
a second shaft disposed to be parallel to the first shaft; and
a third gear and a fourth gear, concentric with the second shaft, respectively disposed in engagement with the first and second gears in positions respectively corresponding to the first and second gears, and rotating together with the second shaft,
wherein elastic members respectively pressing the first gear and the second gear to move toward each other, and movement limiting members respectively limiting axial movements of the first and second gears are provided, and
the protrusion of the first gear or the protrusion of the second gear is latched by one of the latch members of the clutch, by the control member.

2. The transmission structure of claim 1, wherein the clutch moves between a first position in which a first latch member protruding in the first gear direction is latched by the protrusion of the first gear and a second position in which a second latch member protruding in the second gear direction is latched by the protrusion of the second gear, in the first shaft direction.

3. The transmission structure of claim 2, wherein the first latch member and the second latch member of the clutch protrude by a predetermined interval in a circumferential direction, respectively.

4. The transmission structure of claim 3, wherein the movement limiting members comprise a first ring fitted to the first shaft, disposed between the first gear and the second gear and limiting movement of the first gear, and comprising a second ring limiting movement of the second gear, or a step portion formed on the first shaft.

5. The transmission structure of claim 4, wherein the elastic members comprise a first spring disposed opposite to a surface of the first gear facing the second gear, and concentric with the first shaft, and a second spring disposed opposite to an surface of the second gear facing the first gear, and concentric with the first shaft.

6. The transmission structure of claim 5, wherein the first shaft is configured such that a cross-sectional area of one end is larger than a cross-sectional area of the other end, and at least one end portion of the first spring and the second spring is in contact with the step portion of the first shaft.

7. The transmission structure of claim 3, wherein the clutch comprises a first surface facing the first gear, a second surface facing the second gear, and a connection portion connecting the first surface and the second surface and having a cross-sectional area, smaller than a cross-sectional area of each of the first and second surfaces, and
the control member comprises a finger portion fitted into a space between the first and second surfaces and freely moving with respect to rotation of the clutch; a rotating knob exposed from an outer surface of the power equipment; and a branch portion connecting the finger portion and the rotating knob.

8. The transmission structure of claim 7, wherein the rotating knob comprises an eccentric protrusion protruding from an eccentric position of the power equipment toward an inner surface of the power equipment, and
wherein the control member locates the clutch in a first position or a second position by eccentric rotation of the eccentric protrusion.

9. A power tool comprising:
a main body;
a motor provided in the main body;
the transmission structure according to claim 1, connected to the motor; and
a tool connected to an output end of the transmission structure.

10. The power tool of claim 9, wherein an electromagnet is provided in a lower portion of the main body, and
the tool is a drill.
